(19) United States
(12) Patent Application Publication
(10) Pub. No.: US 2019/0136985 A1
(43) Pub. Date: May 9, 2019

(54) FLOW CONTROL VALVE

(71) Applicant: WRI Holdings Ltd., Vancouver (CA)

(72) Inventor: David S. McNamara, Vancouver (CA)

(21) Appl. No.: 16/074,310

(22) PCT Filed: Feb. 1, 2017
(86) PCT No.: PCT/CA2017/050115

§ 371 Date: Jul. 31, 2018

Related U.S. Application Data
(60) Provisional application No. 62/289,692, filed on Feb. 1, 2016.

(51) Int. Cl. F16K 7/06

(52) U.S. Cl. CPC F16K 7/06

(57) ABSTRACT

A flow control valve has a central shaft, with a resilient tubular member extending therethrough and defining a fluid flow path. A plurality of balls are positioned in apertures in the central shaft. A bell housing is engaged with the central shaft for longitudinal movement relative thereto, and has an angled internal camming surface in contact with an outside edge of each one of the balls. Longitudinal movement of the bell housing relative to the central shaft in a first direction causes radially inward movement of the plurality of balls to decrease a cross-sectional area of the fluid flow path.

### CROSS-REFERENCE TO RELATED APPLICATIONS

This application claims priority to, and the benefit of, U.S. provisional patent application No. 62/289,692 filed 1 Feb. 2016, the entirety of which is incorporated by reference herein for all purposes.

### TECHNICAL FIELD

Some embodiments of the present invention relate to valves for controlling a flow of liquid. Some embodiments of the present invention pertain to valves that allow the rate of flow of a liquid through the valve to be controlled with a reasonably good level of precision. Some embodiments of the present invention pertain to methods of using a valve to control the rate of flow of a liquid through the valve.

### BACKGROUND

Good control of the flow rate of a liquid through a valve is important in many settings. Such settings include a variety of industrial contexts, including for example the application of water as a cooling fluid and/or to reduce dust during the cutting or grinding of very hard materials, and also for example in medical contexts, research and analytical laboratories, hydraulic systems, fuel delivery, and so on.

For example, in one exemplary industrial application, when using tools to cut or grind very hard materials, water may be supplied between the cutting/grinding tool and the material being cut or ground. Providing water in this context can help to decrease the amount of dust released to the external environment in the course of the cutting/grinding process, and can help prevent the cutting/grinding tool from overheating and/or being damaged. Fine control of the amount of water supplied is important in this particular context because supplying too little water may result in the production of large amounts of dust and/or overheating or damage to the cutting/grinding tool. Supplying too much water can create a barrier between the cutting/grinding tool and the surface to be cut/ground, which may reduce the cutting speed and/or the level of cutting. Supplying too much water may also result in the location where cutting/grinding is taking place being flooded or becoming overly muddy or messy.

Existing flow control valves have limitations in providing desired degrees of flow control. For example, a ball valve has only ¼ turn between its fully closed and fully open positions. These valves are primarily designed for use in full open/full closed positions, and not for precision flow control. This limited range of adjustability makes fine adjustment of flow rate difficult. Needle valves are susceptible to clogging with material. Gate valves are often intended to move between fully open and fully closed positions when in use. Other valve designs may have other limitations.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a flow control valve having a central shaft having a fluid inlet and a fluid outlet. A resilient tubular member extends through the central shaft, an internal diameter of the resilient tubular member defining a fluid flow path. A plurality of balls are positioned in apertures provided in the central shaft, an inside edge of each one of the balls being in contact with an outside surface of the resilient tubular member. A bell housing is engaged with the central shaft for longitudinal movement relative to the central shaft, the bell housing having an internal camming surface that is in contact with an outside edge of each one of the balls, the internal camming surface being angled outwardly from a first end of the internal camming surface to a second end of the internal camming surface, so that longitudinal movement of the bell housing relative to the central shaft in a direction towards the second end of the bell housing causes radially inward movement of each one of the plurality of balls to thereby decrease a cross-sectional area of the fluid flow path.

Another aspect provides a flow control valve having a central shaft having a fluid inlet and a fluid outlet, and a seating ring provided on an interior surface of the central shaft. A resilient tubular member extends through the central shaft, an internal diameter of the resilient tubular member defining a fluid flow path, a first end of the resilient tubular member being in sealing engagement with the seating ring. A plurality of balls are positioned in apertures provided in the central shaft, an inside edge of each one of the balls being in contact with an outside surface of the resilient tubular member. A bell housing is engaged with the central shaft for longitudinal movement relative to the central shaft, the bell housing having an internal camming surface that is angled outwardly from a first end of the internal camming surface to a second end of the internal camming surface, so that longitudinal movement of the bell housing relative to the central shaft in a direction towards the second end of the bell housing causes radially inward movement of each one of the plurality of balls to thereby decrease a cross-sectional area of the fluid flow path.

In some embodiments, the seating ring comprises an angled surface that is angled inwardly and in the upstream direction from the inside surface of the central shaft that is in contact with the resilient tubular member to form a projection. A downstream tip of the resilient tubular member is engaged over the projection, to help resist deformation of the downstream tip of the resilient tubular member when the plurality of balls are moved radially inwardly.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a side view of a flow control valve according to one example embodiment.

FIG. 2A shows a side view of a central shaft of a flow control valve according to the example embodiment shown in FIG. 1. FIG. 2B shows a partial cross-sectional view of the central shaft of FIG. 2A, with semi-circles indicating the approximate position of the inner portion of the balls within the central shaft, FIG. 2C shows a bottom view thereof, and FIG. 2D shows a top view thereof.

FIG. 3A shows a perspective view of a flow controller of one example embodiment that does not have a seating ring for clarity, in an open position. FIG. 3B shows a perspective view of the flow controller of FIG. 3A in a partially open position. FIG. 3C is a perspective view of the flow controller of FIG. 3A in a fully closed position.

FIG. 3D shows a downstream end view of the embodiment shown in FIG. 3A, with the flow controller in a fully open configuration. FIG. 3E shows a downstream end view of the embodiment shown in FIG. 3A, with the flow controller in a partially open configuration. FIG. 3F shows a downstream end view of the embodiment shown in FIG. 3A, with the flow controller in a fully closed configuration.

FIG. 4A shows a side view of a tubular member for use with one example embodiment. FIG. 4B shows a bottom view thereof, and FIG. 4C shows a top view thereof. FIG. 4D shows a perspective view of a further example of a tubular member for use with another example embodiment.

FIG. 5A shows a side view of a bell housing for use with one example embodiment. FIG. 5B shows a bottom view thereof, and FIG. 5C shows a top view thereof. FIG. 5D is a cross-sectional view of an example bell housing for use with another example embodiment.

FIG. 6A is a side view of a flow control valve according to one example embodiment in an open configuration. FIG. 6B is a side view thereof showing the flow control valve in a partially closed configuration, and FIG. 6C is a side view thereof showing the flow control valve in a fully closed configuration.

FIG. 7A shows an end view of an example embodiment of a flow control valve from the upstream end, with the flow control valve in an open configuration. FIG. 7B is a second end view thereof, with the flow control valve in a slightly closed configuration. FIG. 7C is a third end view thereof, with the flow control valve in an almost fully closed configuration. FIG. 7D is a fourth end view thereof, with the flow control valve in a fully closed configuration.

FIG. 8A is a cross-sectional view of an example embodiment of a flow control valve that does not have a seating ring and with only one ball installed for clarity, with the flow control valve in an open configuration. FIG. 8B is a cross-sectional view thereof, with the flow control valve in a closed configuration. FIG. 8C is a cross-sectional view thereof in an open configuration with the tubular member omitted for clarity and only one ball installed. FIG. 8D is a cross-sectional view of the embodiment of FIG. 8C in the closed configuration.

FIG. 9A is a cross-sectional view showing a central shaft having a seating ring. In the illustrated embodiment of FIG. 9A, the seating ring comprises an angled surface. FIG. 9B is a cross-sectional view showing an alternative embodiment of a central shaft having a seating ring that comprises a flat planar surface. FIG. 9C is a cross sectional view showing a flow control valve having a seating ring that comprises an angled surface, with the tubular member engaged against the seating ring when the flow control valve is in the open configuration. FIG. 9D is a cross-sectional view showing a flow control valve having a seating ring that comprises a generally flat planar surface, with the tubular member engaged against the seating ring when the flow control valve is in the open configuration.

FIG. 10A is a cross-sectional view of an example embodiment of a tubular member having an integral stiffening ring. FIG. 10B is a top view of the integral stiffening ring of FIG. 10A.

FIG. 11A is a side view of an example embodiment of a central shaft having measuring markings thereon. FIG. 11B is a side view of an example embodiment of a bell housing having measuring markings thereon. FIG. 11C is a schematic view of the downstream end of the bell housing of FIG. 11B, showing schematically how the measuring markings are indicated sequentially thereon in one example embodiment. FIG. 11D is a side view of an alternative example embodiment in which measuring markings are marked on a shoulder of the inlet coupler instead of on the central shaft.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the terms “upstream” and “downstream” are used as relative directional terms with reference to the direction of fluid flow through a flow control valve. Fluid, which is water in some embodiments, enters the flow control valve through its upstream end, and travels through the flow control valve, exiting at the downstream end of the flow control valve.

As used herein, the terms “radially inwardly” and “radially outwardly” are used as relative directional terms with reference to a notional central axis of the central shaft of the flow control valve. “Radially inwardly” means in a direction towards the notional longitudinal axis of the central shaft of the flow control valve, and “radially outwardly” means in a direction away from that notional longitudinal axis.

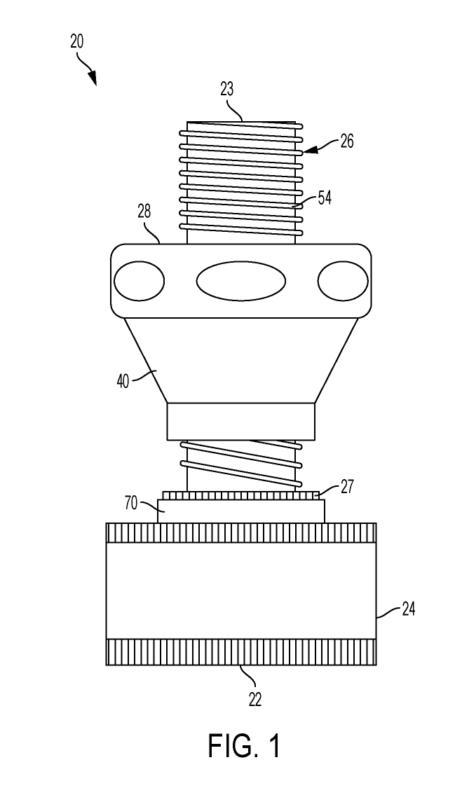

As shown in FIG. 1, in one example embodiment, a flow control valve 20 has a fluid inlet 22 at its upstream end, a fluid outlet 23 at its downstream end, a central shaft 26, and a flow controller 28 in operative engagement with central shaft 26 to control the flow of fluid therethrough.

In the illustrated embodiment, the fluid inlet 22 is provided by a female garden hose coupling 24. This allows flow control valve 20 to be coupled to the correspondingly threaded male end of a conventional garden hose to provide a source of fluid flow (e.g. water) to fluid inlet 22. In alternative embodiments, any suitable fluid connector or adapter could be used to provide fluid inlet 22, having regard to the source of fluid to be used in any given circumstance, including in high pressure applications.

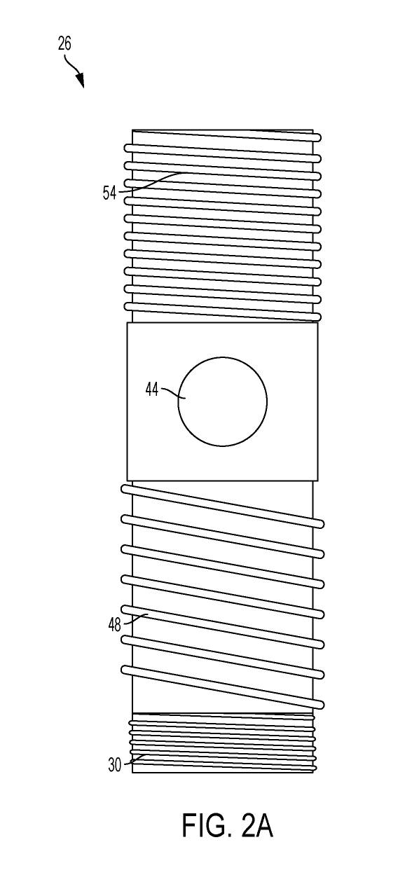

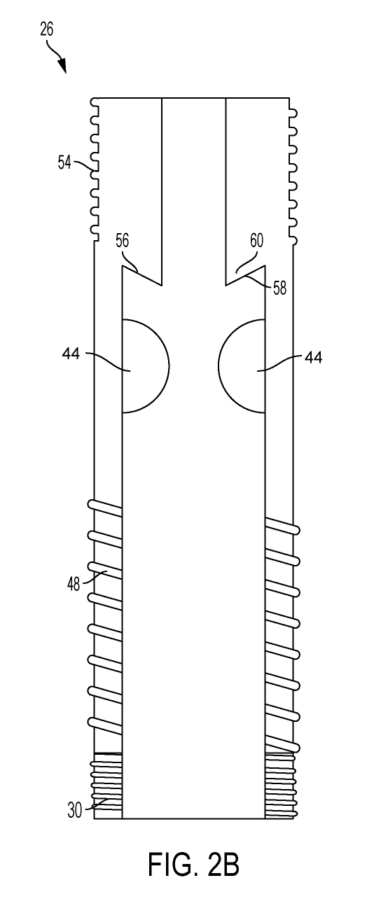

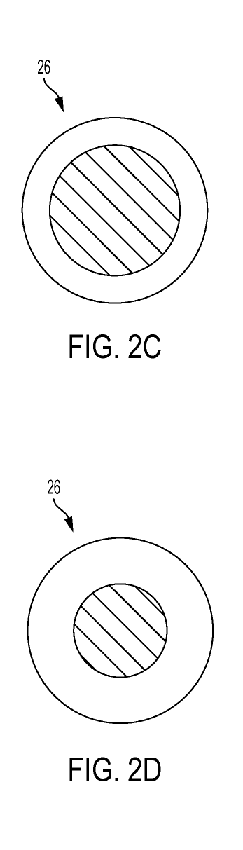

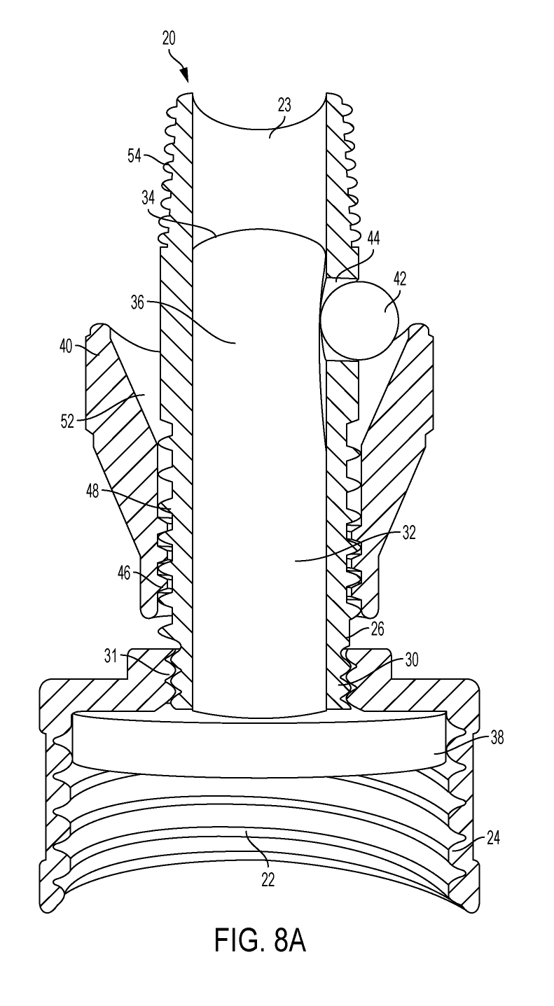

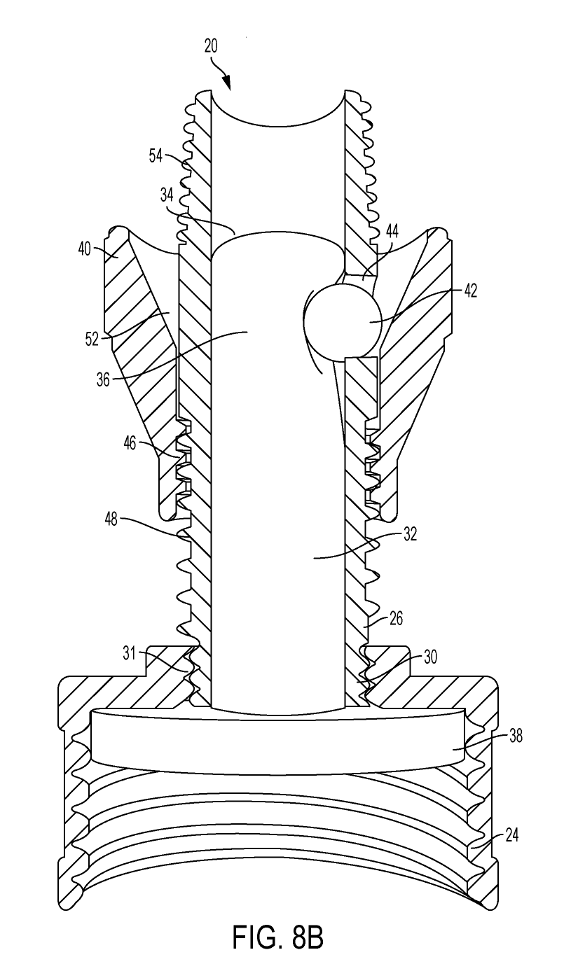

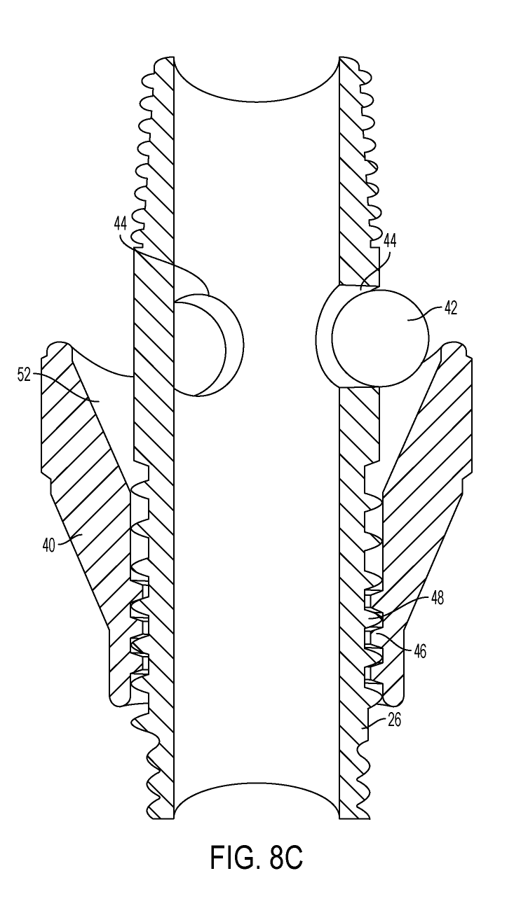

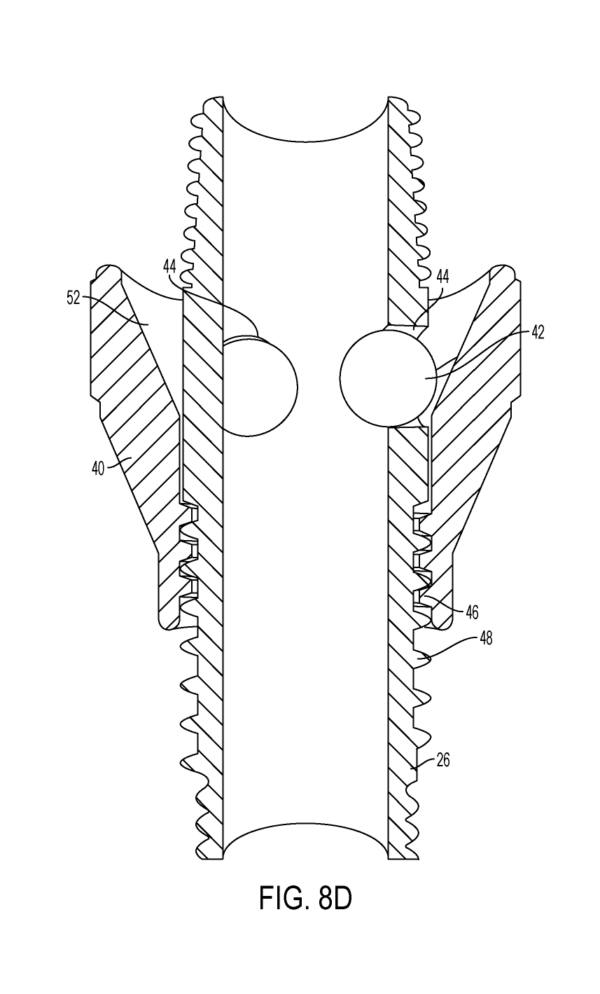

Fluid inlet 22 is coupled to central shaft 26 in any suitable manner. With reference to FIG. 2A, in the illustrated embodiment, central shaft 26 includes a threaded surface 30 at its upstream end. Threaded surface 30 is engaged with a correspondingly threaded surface on fluid inlet 22, for example a correspondingly threaded surface provided on the downstream side of female garden hose coupler 24, visible as threaded surface 31 in FIGS. 8A and 8B. In some embodiments, including the illustrated embodiment of FIG. 1, a washer 27 is provided at the junction of central shaft 26 and female garden hose coupler 24 as an anti-seize washer to ensure mobility when flow control valve 20 is in the fully open configuration, i.e. when bell housing 40 is in its fully upstream position in the illustrated embodiment. In alternative embodiments, other mechanisms could be used to couple fluid inlet 22 to central shaft 26, fluid inlet 22 could be integrally formed with central shaft 26, or the like.

FIGS. 2C and 2D show bottom and top views, respectively of the central shaft of FIG. 2A. The increased thickness of central shaft 26 when viewed from the top as in FIG. 2D arises from the presence of seating ring 56 therein, as described below.

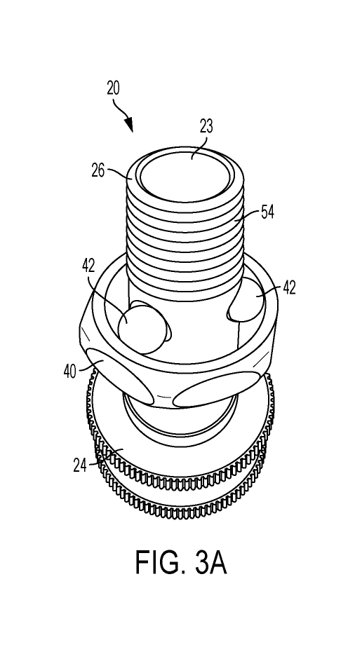

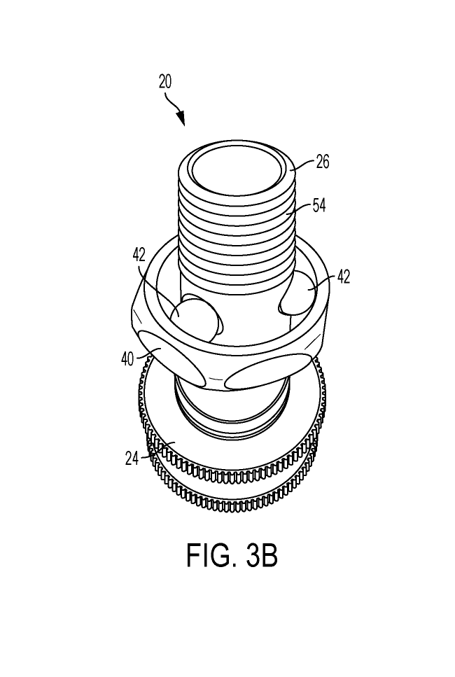

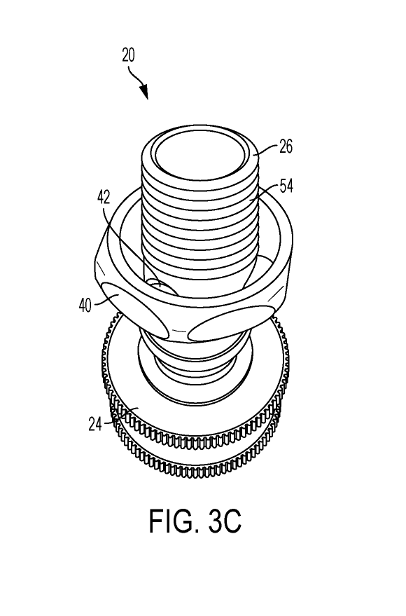

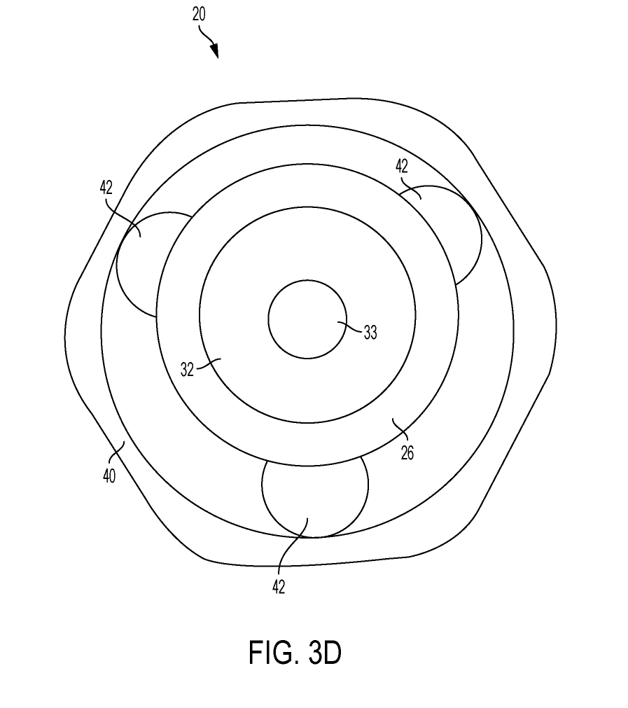

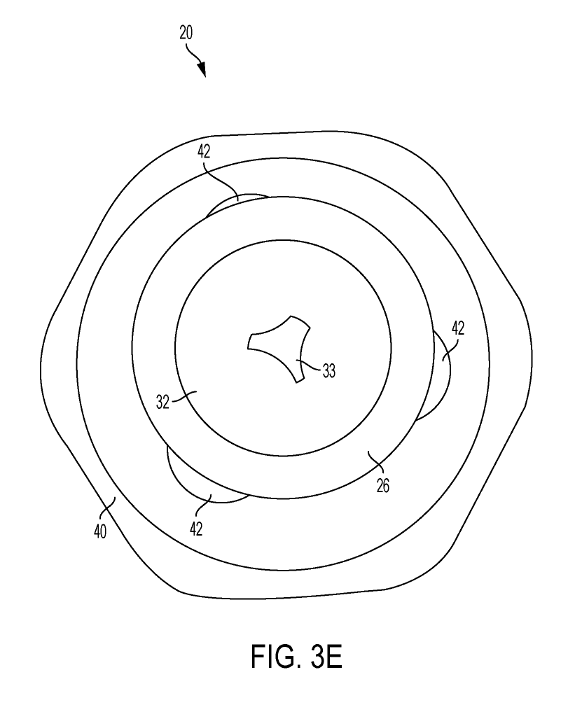

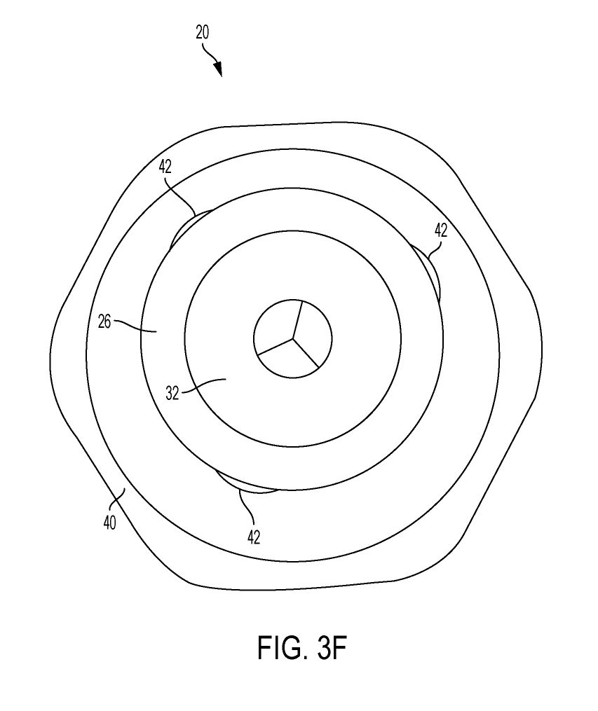

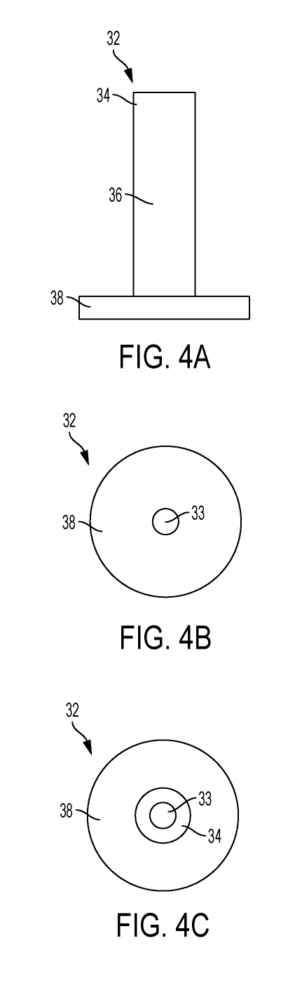

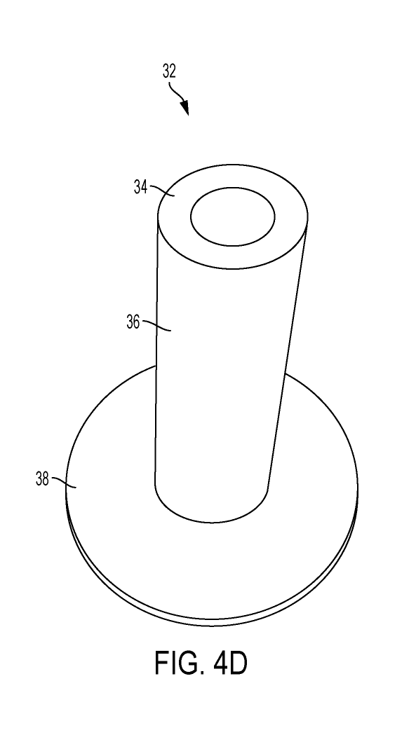

A tubular member 32 (visible in FIG. 3D by virtue of omission of the seating ring from the illustrated embodiment, and shown in detail in FIGS. 4A, 4B, 4C and 4D) sits inside of central shaft 26, and is in fluid communication with both fluid inlet 22 and fluid outlet 23.

Fluid flows through tubular member 32 through a fluid path 33 defined by the inner surface of tubular member 32, and the rate of flow of fluid through tubular member 32 is regulated by flow controller 28 as described in more detail below. In the illustrated embodiment, tubular member 32 has a downstream tip 34, a central portion 36, and an integral washer 38 at its upstream end. In the illustrated embodiment, integral washer 38 sits inside of female garden hose coupler 24, and ensures a good seal between an inlet male end of a garden hose and female garden hose coupler 24. In alternative embodiments, washer 38 could be formed as a separate component and coupled to the central portion 36 of tubular member 32 in any suitable manner.

In the illustrated embodiment, tubular member 32 is sized to fit sealingly within central shaft 26. The length of central portion 36 of tubular member 32 between the upper edge of integral washer 38 and the downstream tip 34 of tubular member 32 is just slightly longer than the corresponding length from the base 29 of central shaft 26 to seating ring 56, so that the downstream tip 34 of tubular member 32 is pressed into and maintains sealing engagement with seating ring 56 by virtue of the engagement of integral washer 38 against female garden hose coupler 24.

In the illustrated embodiment, with reference in particular to FIG. 3A-3F and also FIGS. 7A-7D described below, flow controller 28 operates to control flow by adjusting the cross-sectional area of fluid path 33, based on principles similar to those described in U.S. Pat. No. 3,550,861 to Teson, which is incorporated by reference herein for all purposes. Flow controller 28 comprises a bell housing 40 and a plurality of balls 42 spaced apart circumferentially within the bell housing 40. In the illustrated embodiment, three balls 42 are used. However, in alternative embodiments, the number of balls 42 used could be varied, so long as balls 42 can be moved outwardly or inwardly relative to one another to increase or decrease, respectively, the cross-sectional surface area of fluid path 33 as described below.

Balls 42 are seated within apertures 44 (FIG. 2A) provided on central shaft 26 in a manner that permits balls 42 to move radially inwardly or outwardly in response to pressure applied by bell housing 40 as described below. The diameter of apertures 44 is just slightly larger than the diameter of balls 42, so that balls 42 can move radially inwardly or radially outwardly within apertures 44, but do not move to an appreciable extent in longitudinal or circumferential directions relative to central shaft 26. Balls 42 are also in contact with the radially outward surface of central portion 36 of tubular member 32, so that radially inward motion of balls 42 causes compression of tubular member 32 in the radially inward direction, thereby narrowing the cross-sectional area of fluid path 33, e.g. as shown in FIG. 3E.

To prevent balls 42 from moving too far radially inwardly and thereby potentially moving longitudinally out of apertures 44, in some embodiments, the diameter of balls 42 (and consequently the corresponding diameter of apertures 44) is larger than the largest possible diameter of fluid path 33 defined by the inside surface of tubular member 32. In this way, given that balls 42 will come into contact with one another as they move inwardly inside central shaft 26, balls 42 prevent one another from moving too far radially inwardly so as to be displaced from apertures 44.

Balls 42 are held in place within apertures 44 by contact with the outer surface of tubular member 32, by the circumferential edges of apertures 44, and by contact with the inner surface of bell housing 40, as described in greater detail below. Bell housing 40 is provided with a threaded surface 46 on the inside surface of its upstream end 47, for engagement with a correspondingly threaded surface 48 provided on the outside surface of central shaft 26.

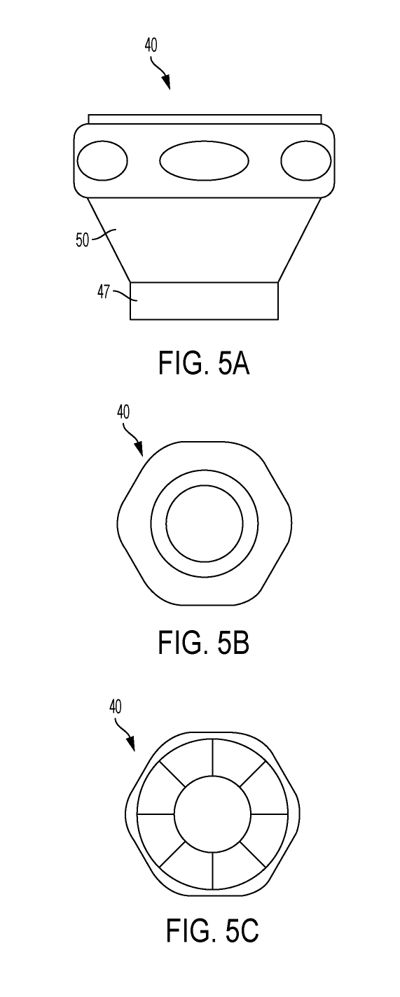

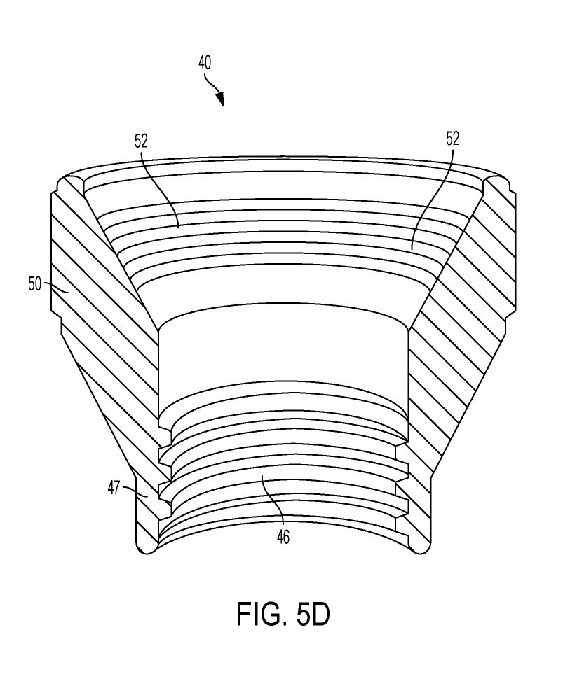

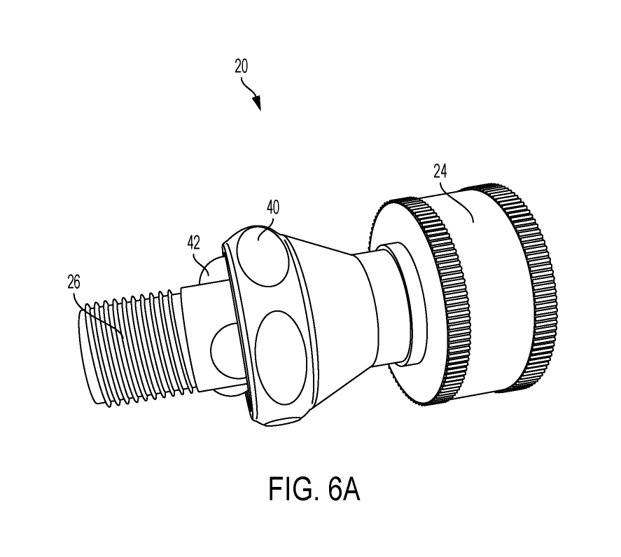

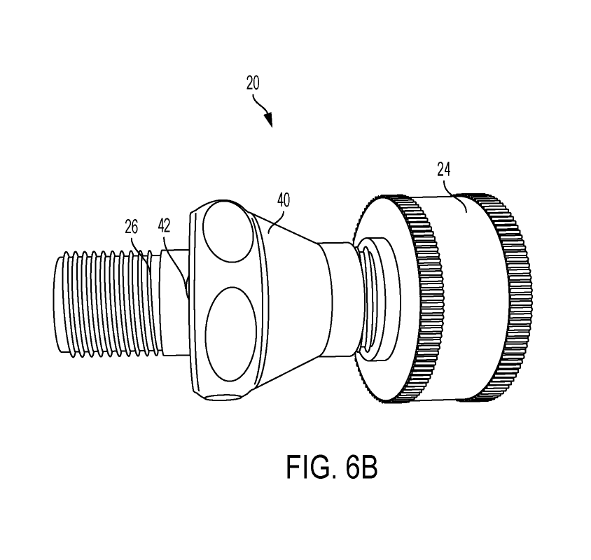

With reference to FIGS. 5A, 5B, 5C and 5D, bell housing 40 also has a downstream body portion 50 that, in the illustrated embodiment, flares radially outwardly in the downstream direction. The shape of the outer surface of bell housing 40 can be varied in alternative embodiments. The inner surface 52 (referred to hereafter as internal camming surface 52) of downstream body portion 50 flares radially outwardly in the downstream direction, so that internal camming surface 52 provides a generally conical surface that tapers radially outwardly in the downstream direction. Internal camming surface 52 is in contact with the outside edges of balls 42. As internal camming surface 52 moves longitudinally relative to central shaft 26 (and therefore relative to balls 42), the extent to which balls 42 are forced radially inwardly into fluid path 33 is varied.

More specifically, when bell housing 40 is in its fully upstream position, e.g. as shown in FIGS. 3A and 3D, balls 42 are at their radially outwardmost position, and fluid path 33 is fully or relatively unobstructed. Thus, flow control valve 20 is in its fully open position. As bell housing 40 is moved longitudinally downstream via rotational movement about threads 46, 48, the diameter of the portion of internal camming surface 52 that is in contact with the outside edges of balls 42 is decreased, which forces balls 42 to move radially inwardly inside central shaft 26, thereby decreasing the cross-sectional surface area of fluid path 33, e.g. as shown in FIGS. 3B and 3E. When bell housing 40 is placed in its fully downstream longitudinal position, balls 42 are forced radially inwardly to the fullest extent possible, resulting in fluid path 33 being fully closed to fluid flow (i.e. so that there is no flow of liquid through the flow control valve), e.g. as shown in FIGS. 3C and 3F.

Longitudinal movement of bell housing 40 in the upstream direction relative to central shaft 26 causes the opposite effect, i.e. the diameter of the portion of internal camming surface 52 that is in contact with the outside edges of balls 42 is increased, so that balls 42 can move radially outwardly within apertures 44 due to the force applied by tubular member 32 (and/or the fluid flowing through fluid path 33).

In the illustrated embodiment, bell housing 40 is longitudinally movable with respect to central shaft 26 by virtue of the engagement of correspondingly threaded surfaces 46 (of bell housing 40) and 48 (of central shaft 26). Relative rotational movement of bell housing 40 by a user causes bell housing 40 to move longitudinally in either the upstream or downstream direction with respect to central shaft 26. Because a relatively large degree of relative rotation of bell housing 40 about central shaft 26 produces only a small change in the longitudinal position of bell housing 40 relative to central shaft 26, very fine control of the cross-sectional area of fluid path 33 is provided, which in turn provides very fine control of the rate of fluid flow through flow control valve 20.

In alternative embodiments, other methods for moving bell housing 40 longitudinally relative to central shaft 26 could be used to control the movement of internal camming surface 52 against balls 42. Also in alternative embodiments, internal camming surface 52 need not have a substantially linear shape as illustrated, but could be provided with other shapes, e.g. slightly curved, so long as internal camming surface 52 can be longitudinally moved to vary the radial position of balls 42.

It will be apparent to those skilled in the art that the relative upstream and downstream orientation of the threaded surface 46 and camming surface 52 could be reversed in alternative embodiments, provided that threaded surface 48 is provided on central shaft 26 downstream of apertures 44 in such embodiments. That is, the orientation of bell housing 40 with respect to central shaft 26 could be reversed by 180° in alternative embodiments. In further alternative embodiments, the relative orientation of internal camming surface 52 could be reversed by 180°, i.e. so that the diameter of internal camming surface 52 that is in contact with balls 42 is smallest when bell housing 40 is in the fully upstream position, and is largest when bell housing 40 is in the fully downstream position. What is important is that bell housing 40 can in some manner be moved in a longitudinal direction relative to central shaft 26, and that bell housing 40 have an internal camming surface, so that longitudinal movement of bell housing 40 relative to central shaft 26 causes balls 42 to move radially inwardly or outwardly, so that the cross-sectional surface area of fluid path 33 is varied.

In the illustrated embodiment, central shaft 26 includes a downstream threaded surface 54 at its downstream end, so that fluid outlet 23 can be coupled to any desired element. For example, in some embodiments, a hydraulic coupler could be threaded onto downstream threaded surface 54, to couple flow controller 20 to downstream hydraulic equipment or other devices. In alternative embodiments, the downstream end of central shaft 26 could be provided with any desired engagement mechanism to allow flow control valve 20 to be coupled to any desired piece of equipment.

In the illustrated embodiment, threads 30, 48 and 54 are drawn as reverse threads. In alternative embodiments, threads 30, 48 and 54 could independently alternatively be standard threads. In one example embodiment, threads 30 and 54 are standard threads, while threads 48 are reverse threads. In some such embodiments, if bell housing 40 seizes up (i.e. becomes stuck and difficult to move along threads 48), the fact that threads 48 are reverse threads while threads 30 and 54 are standard threads allows a user to apply significant force against bell housing 40 to dislodge bell housing 40 for free movement along threads 48, without a risk of inadvertently uncoupling the garden hose or other upstream source of supply water or any downstream tool to which flow control valve 20 is coupled via threads 30 or 54.

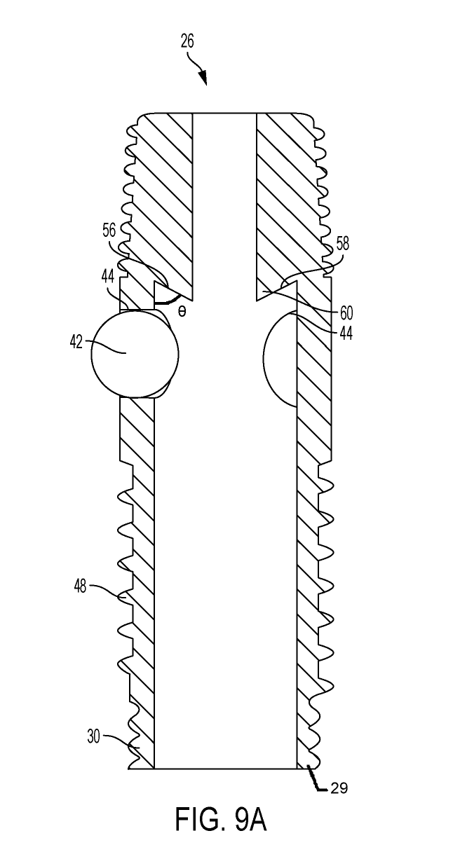

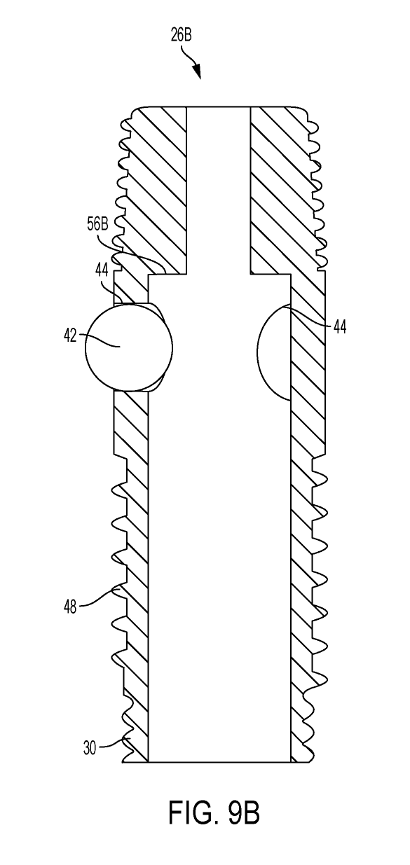

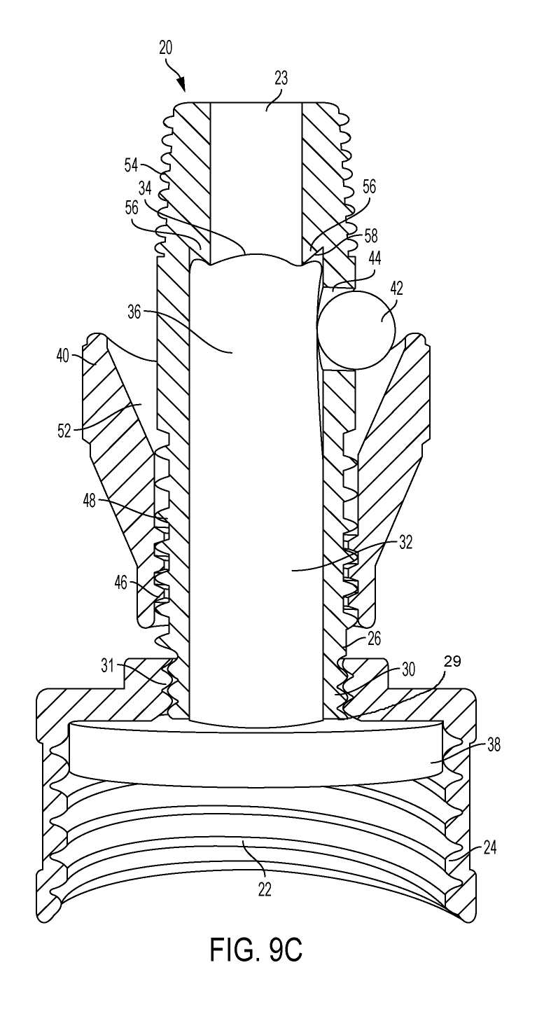

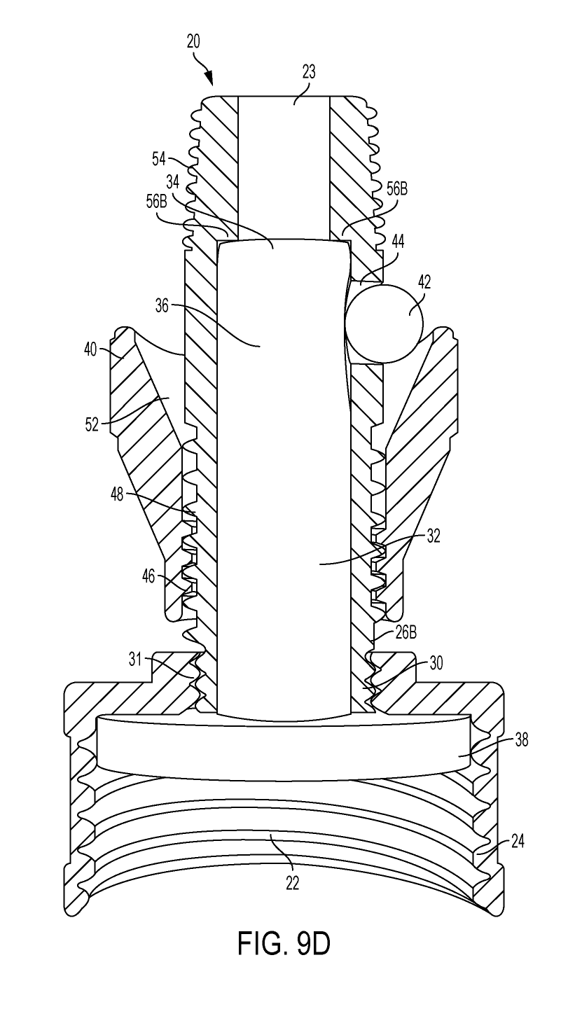

Because flow control valve 20 is coupled to a downstream device or other piece of equipment into which fluid is fed, a backpressure is generated within fluid path 33. To prevent this backpressure from causing fluid to leak out of flow control valve 20, in some embodiments, central shaft 26 is configured to provide a seating ring 56 (e.g. FIG. 2B) against which the downstream tip 34 of tubular member 32 can seal. In the illustrated embodiment of FIG. 2B, seating ring 56 holds tubular member 32 (not shown in FIG. 2B) in place and creates a pressure contact seal to prevent leakage caused by backpressure when connected to a coupler or shut-off device downstream, as best shown in FIGS. 9C and 9D. As bell housing 40 moves longitudinally downstream along central shaft 26, tubular member 32 is compressed, and forms an even tighter seal against seating ring 56. In some embodiments, a sealant such as silicone or other suitable material is applied to seating ring 56 where it contacts downstream tip 34 or tubular member 32, to enhance the seal formed between these components. In some embodiments, a bead of a sealant such as silicone or other material can provide seating ring 56.

In the illustrated embodiment of FIG. 2B and shown in FIG. 9A, seating ring 56 comprises an angled surface 58. Angled surface 58 is angled inwardly in the upstream direction by an angle θ from the inner surface of central shaft 26 to form a projection 60. The central shaft 26 shown in FIG. 9A has a constant cross section about its diameter, i.e. angled surface 58 is provided as a fully revolved feature having a circular shape about the inside surface of shaft 26, so that the circular downstream tip 34 of tubular member 32 can be pushed into contact with angled surface 58. Angled surface 58 helps to both hold downstream tip 34 of tubular member 32 in place (e.g. to prevent radially inwardly deflection and/or deformation of downstream tip 34 that might otherwise occur by reason of the radially inward force applied by balls 42 as flow control valve 20 is closed), and to ensure a good seal between downstream tip 34 and seating ring 56. Thus, in some embodiments, the downstream tip 34 of tubular member 32 is engaged over projection 60, as shown in FIG. 9C.

In alternative embodiments, as shown for example in FIG. 9B, angled surface 58 and projection 60 could be omitted, and seating ring 56 could simply comprise a generally flat radially extending surface for contacting downstream tip 34 of tubular member 32. This is illustrated as central shaft 26B having a generally flat, radially inwardly extending seating ring 56B in FIG. 9B, and could also be regarded as an embodiment in which angle θ is 90°.

Ranges of angles θ that can be used to provide angled surface 58 of seating ring 56 vary from about 30° to just under 90°, including any value therebetween e.g. 35°, 40°, 45°, 50°, 55°, 60°, 65°, 70°, 75°, 76°, 77°, 78°, 79°, 80°, 80.5°, 81°, 81.5°, 82°, 82.5°, 83°, 83.5°, 84°, 84.5° °, 85, 85.5°, 86°, 86.5°, 87°, 87.5°, 88°, 88.5°, 89°, 89.5°, or just under 90°. In one example embodiment constructed and tested by the inventor, angle θ is approximately 85°.

As illustrated in FIGS. 9A and 9B, in one example embodiment, to provide a seating ring 56 or 56B, the interior diameter of the downstream portion of central shaft 26 would be reduced so that seating ring 56 or 56B is provided on the interior surface of central shaft 26 at a location to contact downstream tip 34 of tubular member 32, as shown in FIGS. 9C and 9D. In some such embodiments, seating ring 56 is provided with an angled surface 58 to provide a projection 60, as described above, so that the downstream tip 34 of tubular member 32 is fitted over the seating ring 58, as shown in FIG. 9C.

In alternative embodiments, seating ring 56 or 56B could be provided as other than an integrally formed component of central shaft 26. For example, in some embodiments, a seating member is separately formed from a suitable material and adhered to the inside surface of central shaft 26 to provide seating ring 56 or 56B. What is important is that seating ring 56 or 56B provide a sealing barrier to prevent fluid escaping between downstream tip 34 of tubular member 32 and central shaft 26.

For example, the inventor has created prototypes that use a silicone seal provided on the inside surface of central shaft 26 to provide seating ring 56. Such prototypes have been shown to prevent leakage for at least six months in field testing, and could handle pressures of up to about 75 psi (5 atm) without failure. Such prototypes in which a silicone seal is used to provide the seating ring also do not include angled surface 58 or projection 60 on the seating ring. Similarly, prototypes constructed by the inventor and having a flat seating ring 56B (i.e. an example embodiment in which angle θ is approximately 90°) have similarly been found to be capable of handling pressures up to about 75 psi (5 atm) without failure. Thus, angled surface 58 and/or projection 60 can be omitted in some embodiments.

The inventor has produced prototypes in accordance with the example embodiment illustrated in FIG. 9A that include angled surface 58 and have an angle θ of approximately 85° that have allowed directional flow of fluids through the valve to be reversed without any adverse effect or bearing bleed at pressures in excess of 200 psi (13.6 atm) in preliminary testing, and without failure even up to pressures of 2500 psi (170 atm).

In the illustrated embodiment of FIGS. 9C and 9D, the upstream end of tubular member 32 is securely and sealingly held in place by the engagement of integral washer 38 of tubular member 32 between female garden hose coupler 24 and the male end of a garden hose to which flow control valve 20 can be attached. Thus, in use, the upstream end of tubular member 32 is also secured in position and sealed so as to avoid leakage of fluid from flow control valve 20. In some embodiments, securing the upstream end of tubular member 32 also assists to ensure that a good seal is maintained between downstream tip 34 of tubular member 32 and seating ring 56, for example by helping to keep tubular member 32 from being displaced by forces applied by balls 42.

The inventor has found that it is important to ensure that balls 42 are placed a sufficient distance upstream from the downstream tip 34 of tubular member 32, to ensure that when balls 42 compress tubular member 32 inwardly to narrow fluid path 33, downstream tip 34 does not thereby get moved out of contact with seating ring 56 or 56B. Moving balls 42 even as little as two millimeters upstream from seating ring 56 has been found to make a significant difference in the resistance of some tested example embodiments to backpressure.

With reference to FIGS. 8A, 8B, 8C and 8D, an alternative embodiment of a flow control valve 20 is illustrated. In the embodiment shown in these figures, the central shaft 26 does not include a seating ring 56 to assist in more clearly showing the operation of flow control valve 20. Otherwise, the components of central shaft 26 are the same, and like reference numerals will be used to refer to like parts of central shaft 26. Only one ball 42 is illustrated in FIGS. 8A-8B for clarity in showing the movement of tubular member 32.

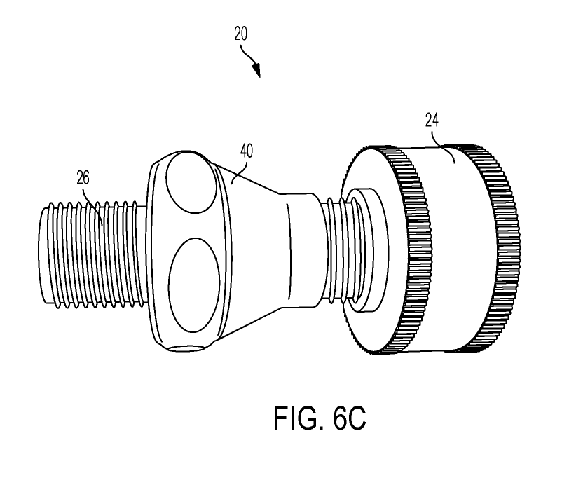

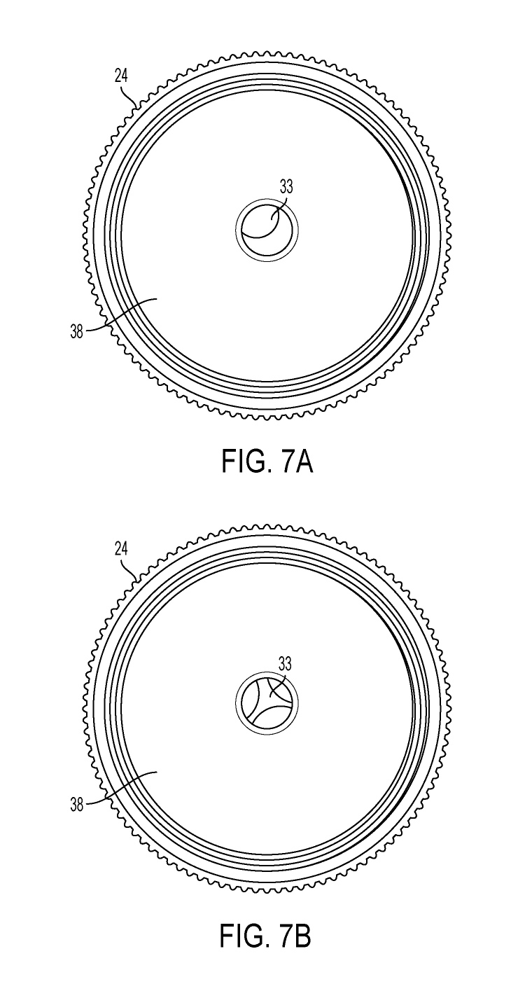

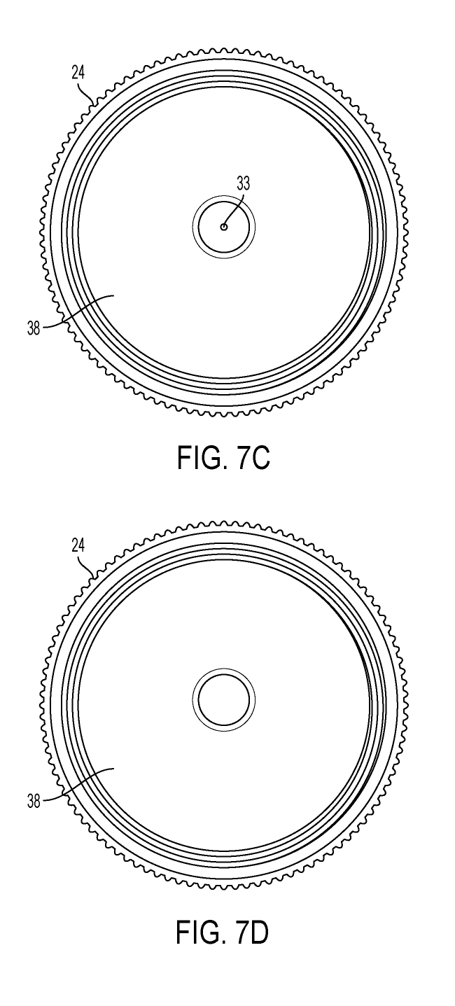

With reference to FIGS. 6A-6C and 8A-8D, the longitudinal movement of bell housing 40 with respect to central shaft 26 can be clearly seen. In FIGS. 6A and 8A, flow control valve 20 is in its fully open configuration, and bell housing 40 is at its farthest upstream point of travel longitudinally with respect to central shaft 26. Balls 42 are at their radially outwardmost position.

As the bell housing 40 is rotated along threads 46, 48, bell housing 40 moves longitudinally in the downstream direction with respect to central shaft 26 (e.g. FIG. 6B). The diameter of the portion of internal camming surface 52 that is in contact with the outside edge of balls 42 progressively decreases as bell housing 40 moves longitudinally in the downstream direction, until flow control valve 20 is placed in the fully closed configuration, at which point bell housing 40 is positioned at its farthest longitudinally downstream position relative to central shaft 26 (e.g. FIGS. 6C and 8B). In this position, balls 42 are at their radially most inward position. As shown in FIG. 8B, radially inward movement of balls 42 deflects tubular member 32 inwardly at the point of contact with the inside edges of balls 42, causing the cross-sectional surface area of the fluid path 33 defined by the inside circumference of tubular member 32 to be decreased.

The radial movement of balls 42 is shown more clearly in FIGS. 8C and 8D, in which tubular member 32 has been omitted for clarity. In FIG. 8C, flow control valve 20 is in its fully open configuration, balls 42 are at their radially outwardmost positions against internal camming surface 52. In FIG. 8D, bell housing 40 has been moved longitudinally relative to central shaft 26 to its farthest downstream position so that flow control valve 20 is in its fully closed position, and balls 42 are now at their radially inwardmost position against internal camming surface 52.

The progressive decrease in the cross-sectional area of fluid path 33 is best shown in FIGS. 7A, 7B, 7C and 7D. As shown in FIG. 7A, when flow control valve 20 is in the open configuration, and balls 42 are at their radially outwardmost position, fluid path 33 has a relatively large cross-sectional area. As bell housing 40 is moved longitudinally relative to central shaft 26 to cause internal camming surface 52 to move balls 42 radially inwardly, the cross-sectional area of fluid path 33 is decreased, as shown in FIG. 7B. FIG. 7C shows the effect of continued movement of bell housing 40, and also illustrates the high degree of control of the cross-sectional area of fluid path 33 that can be achieved by fluid control valve 20, because a relatively large amount of rotational movement of bell housing 40 about threads 46, 48 yields only a small degree of change in the longitudinal position of bell housing 40 relative to central shaft 26, allowing for very fine control of the longitudinal position of bell housing 40, and hence of the cross-sectional area of fluid path 33. In FIG. 7C, fluid path 33 has been reduced to a barely visible channel, that allows very small amounts of water to be fed through flow control valve 20. In FIG. 7D, fluid path 33 has been completed closed off by the radially inward movement of balls 42, so that flow control valve 20 is in its fully closed position, and will allow no fluid to pass.

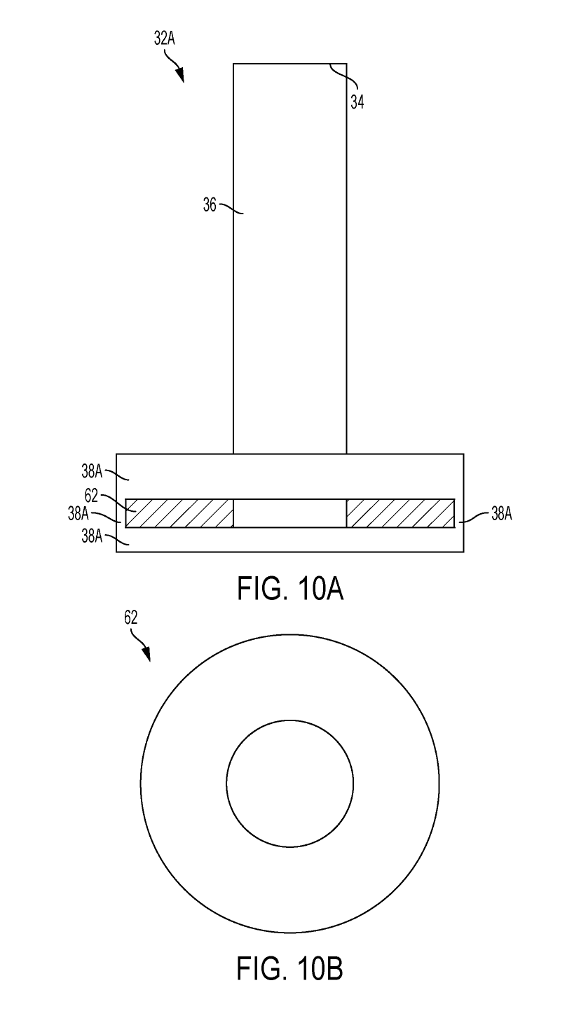

In some embodiments, a stiffening ring is provided to stiffen integral washer 38 of tubular member 32. With reference to FIGS. 10A and 10B, an example embodiment of a tubular member 32A is illustrated, which has an integral stiffening ring 62 provided within integral washer 38A thereof. In some embodiments, stiffening ring 62 is formed as an overmold of a relatively more rigid material on tubular member 32A. However, stiffening ring 62 can be provided as a separate component in alternative embodiments. Additionally, stiffening ring 62 need not be provided within integral washer 38A, but for example could be securely adhered to integral washer 38 in alternative embodiments. When present, stiffening ring 62 helps to prevent tubular member 32 from backing out of seating ring 56, and can also help to ensure good contact of washer 38 and thus a good seal at female garden hose coupler 24.

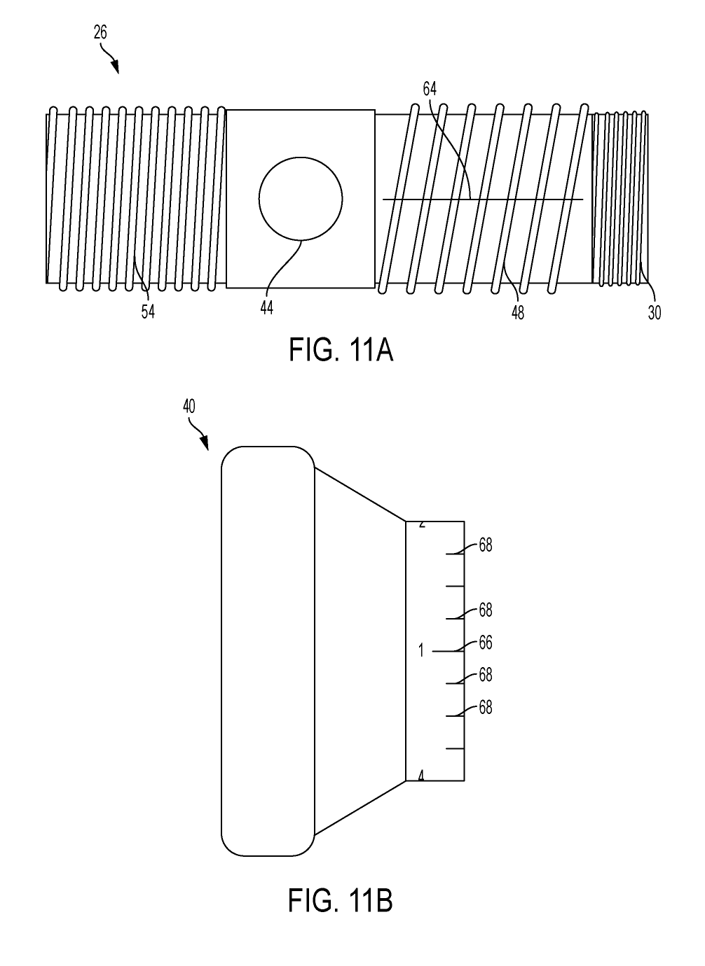

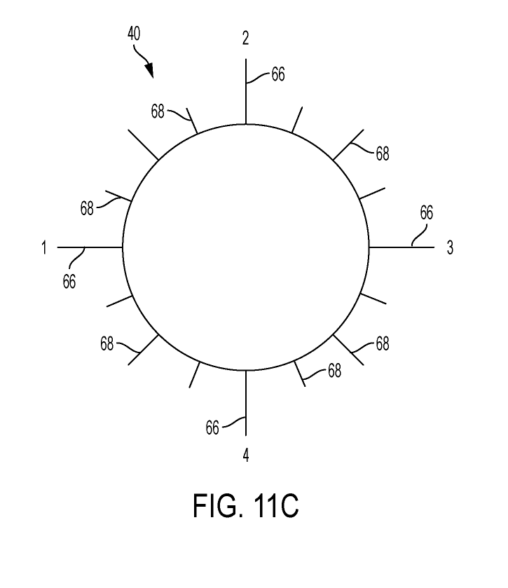

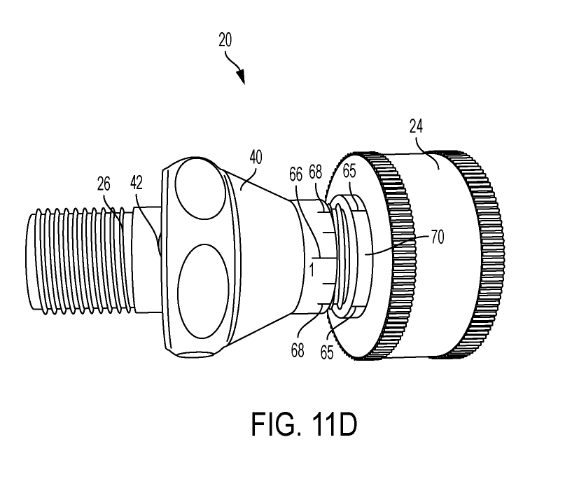

In some embodiments, markings are provided on central shaft 26 and bell housing 40 or on any available visible surface to assist a user in achieving a particular rate of fluid flow through flow control valve 20. With reference to FIG. 11A, in one example embodiment, three longitudinally extending lines 64 are marked along the outer surface of central shaft 26. In some embodiments, as shown in FIG. 11A, the three longitudinally extending lines 64 are scored into the outer surface of central shaft 26, although any suitable means of marking could be used. In alternative embodiments, other numbers of longitudinally extending marking lines 64 could be used, e.g. one or two, or more than three. In some embodiments, three longitudinally extending marking lines 64 are easier to see than a single line, for example because in some operating positions a user might be looking at the side of central shaft 26 that is opposite to the position of a single longitudinally extending marking line 64. In some embodiments, the longitudinally extending marking lines 64 are circumferentially equally spaced about the outside surface of central shaft 26.

In some embodiments, a plurality of dashed markings are provided on the outside surface of bell housing 40. In some such embodiments, the plurality of dashed markings are provided at the upstream end of bell housing 40, as illustrated in FIG. 11B. In some embodiments, the plurality of dashed markings are scored into the outside surface of bell housing 40, although any suitable means of marking could be used. In some embodiments, including the illustrated embodiment, the plurality of dashed markings are differentiated, for example by having one longer marking 66 interposed by one or a plurality of shorter markings 68. In some embodiments, the plurality of dashed markings 66, 68 are sequentially numbered. In some embodiments, including the illustrated embodiment, only the longer markings 66 of the plurality of dashed markings are numbered.

For example, as shown in FIG. 11B and schematically in FIG. 11C, four longer markings 66 are provided on bell housing 40, and are equally circumferentially spaced around the upstream end of bell housing 40. Each one of the four longer markings 66 is sequentially numbered circumferentially, i.e. each longer marking 66 would be physically labelled as 1, 2, 3 and 4, respectively, on the bell housing 40. Three shorter markings 68 are provided between each adjacent pair of longer markings 66, and shorter markings 68 are likewise equally circumferentially spaced apart from each other and from longer markings 66.

To read the markings, according to one example, the user can count the number of threads visible along central shaft 26 between female garden hose coupler 24 and the upstream edge of bell housing 40 along the most easily viewed longitudinally extending marking line 64 on central shaft 26. In one example embodiment, there could be a maximum of four such threads visible when bell housing 40 is at its farthest downstream position. The markings 66, 68 on bell housing 40 indicate the setting relative to the most easily viewed longitudinally extending marking line 64 on central shaft 26. In one hypothetical example embodiment, there are five long dashed markings 66 about the circumference of bell housing 40, with four short markings 68 between each adjacent pair of long dashed markings 66. In one such embodiment, the user counts the number of threads visible on central shaft 26 (e.g. 3), the sequential number indicated by the long dashed marking 66 (e.g. 2), and the number of short marks 68 to the most easily viewed longitudinally extending marking line 64 on central shaft 26 (e.g. 4) to count the flow rate. In this specific example, the flow rate setting would be 3 2/4 (i.e. 3 threads, long dashed marking 2, plus four short marks). This allows a user to easily set flow control valve 20 to a particular flow rate, adjust if necessary at a particular point in time, and then accurately return to the original flow rate setting when it is desired to do so.

As shown in FIG. 11D, in some embodiments instead of longitudinally extending marking lines 64 being marked on central shaft 26, one or more longitudinally extending marking lines 65 are marked on a shoulder 70 of inlet coupler 24, which may potentially increase the visibility of such marking lines if the threading 48 on central shaft 26 becomes dirty. The position of the longitudinally extending marking lines 65 on shoulder 70 can be used in the same manner as described above for longitudinally extending marking lines 64 to easily set flow control valve 20 to a particular flow rate. In alternative embodiments, longitudinally extending marking lines 65 could be provided on any visible portion of inlet coupler 24.

Suitable materials for the manufacture of various components of flow control valve 20 can be determined by those skilled in the art. For example, brass or other suitable metal can be used to fabricate central shaft 26, female garden hose coupler 24, and bell housing 40. Any suitably rigid material, including e.g. metal or plastic, can be used for balls 42. Any suitable type of flexible material (e.g. rubber or soft plastic) can be used to provide tubular member 32.

While flow control valve 20 has been described and illustrated as having a generally symmetrical configuration (i.e. with three circumferentially equally spaced balls 42 provided), it will be apparent to those skilled in the art that other numbers of balls 42 and other configurations (e.g. unequal or asymmetrical spacings of balls 42) could be used in alternative embodiments.

In use, a user can couple fluid inlet 22 to any desired source of fluid, e.g. a male end of a garden hose supplying water. A user can also couple fluid outlet 23 to any desired downstream device or piece of equipment (e.g. a tool for cutting or grinding hard materials), for example by threading a hydraulic coupling onto downstream threaded surface 54. The source of fluid can then be activated (e.g. the garden hose turned on), to supply fluid to flow control valve 20. A user can then manually regulate the rate of flow of fluid through flow control valve 20 by rotating bell housing 40 until a desired flow rate is achieved.

For example, in one embodiment, a user couples fluid inlet 22 to a source of fluid, couples fluid outlet 23 to a downstream device, rotates bell housing 40 to its fully downstream position, so that flow control valve 20 is in its fully closed position. A user then turns on the source of fluid, although no fluid is permitted to pass through flow control valve 20. A user then takes whatever steps are necessary to prepare the downstream device for use, and then, when ready, rotates bell housing 40 to move bell housing 40 longitudinally in the upstream direction with respect to central shaft 26. This allows fluid to begin flowing through flow control valve 20. The user continues to rotate bell housing 40 until the desired flow rate is achieved. Once whatever activity that is being carried out is completed, a user can optionally rotate bell housing 40 so that it moves longitudinally in the downstream direction until flow control valve 20 is back in its fully closed position.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as consistent with the broadest interpretation of the specification as a whole.

1. A flow control valve comprising:
a central shaft having a fluid inlet and a fluid outlet, and a seating ring provided on an interior surface of the central shaft;
a resilient tubular member extending through the central shaft, an internal diameter of the resilient tubular member defining a fluid flow path, a first end of the resilient tubular member being in sealing engagement with the seating ring;
a plurality of balls positioned in apertures provided in the central shaft, an inside edge of each one of the balls being in contact with an outside surface of the resilient tubular member;
a bell housing engaged with the central shaft for longitudinal movement relative to the central shaft, the bell housing having an internal camming surface that is in contact with an outside edge of each one of the balls, the internal camming surface being angled outwardly from a first end of the internal camming surface to a second end of the internal camming surface;
so that longitudinal movement of the bell housing relative to the central shaft in a direction towards the second end of the bell housing causes radially inward movement of each one of the plurality of balls to thereby decrease a cross-sectional area of the fluid flow path.

2. A flow control valve comprising:
a central shaft having a fluid inlet and a fluid outlet;
a resilient tubular member extending through the central shaft, an internal diameter of the resilient tubular member defining a fluid flow path;
a plurality of balls positioned in apertures provided in the central shaft, an inside edge of each one of the balls being in contact with an outside surface of the resilient tubular member;
a bell housing engaged with the central shaft for longitudinal movement relative to the central shaft, the bell housing having an internal camming surface that is in contact with an outside edge of each one of the balls, the internal camming surface being angled outwardly from a first end of the internal camming surface to a second end of the internal camming surface;
so that longitudinal movement of the bell housing relative to the central shaft in a direction towards the second end of the bell housing causes radially inward movement of each one of the plurality of balls to thereby decrease a cross-sectional area of the fluid flow path.

3. A flow control valve as defined in claim 2, wherein the bell housing is in threaded engagement with the central shaft, so that rotational movement of the bell housing relative to the central shaft is translated to longitudinal movement of the bell housing relative to the central shaft.

4. A flow control valve as defined in claim 2, wherein the central shaft comprises a seating ring on an internal surface of the central shaft, a first end of the resilient tubular member being in contact with the seating ring.

5. A flow control valve as defined in claim 4, wherein the seating ring comprises a silicone seal.

6. A flow control valve as defined in claim 4, wherein the seating ring comprises a seal formed of a suitable material and coupled to the inside surface of the central shaft.

7. A flow control valve as defined in claim 4, wherein the seating ring is integrally formed with the central shaft.

8. A flow control valve as defined in claim 6, wherein the seating ring comprises an angled surface that tapers radially inwardly and in the upstream direction from an inside surface of the central shaft to provide a projection, optionally wherein an angle θ defined between an inside surface of the central shaft and the angled surface is between 30° and just less than 90°, optionally between about 82° and 88°.

9. A flow control valve as defined in claim 8, wherein the first end of the resilient tubular member is engaged over the projection.

10. A flow control valve as defined in claim 4, wherein the seating ring comprises a surface that is generally flat in the radially inward direction.

11. A flow control valve as defined in claim 4, wherein the seating ring comprises a sealant material at a location where the seating ring contacts the tubular member, and wherein the sealant material optionally comprises silicone.

12. A flow control valve as defined in claim 4, wherein a second end of the resilient tubular member comprises an integral washer.

13. A flow control valve as defined in claim 4, wherein a diameter of the balls is larger than a diameter of the fluid flow path when the flow control valve is in an open configuration.

14. A flow control valve as defined in claim 4, wherein the plurality of balls comprises three circumferentially spaced apart balls.

15. A flow control valve as defined in claim 4, comprising markings on both an outer surface of the central shaft and an outer surface of the bell housing for setting a flow rate of the flow control valve to a predetermined level.

16. A flow control valve as defined in claim 15, wherein the markings on the outer surface of the central shaft comprise a plurality of longitudinally extending lines, and wherein the plurality of longitudinally extending lines are optionally scored into the outer surface of the central shaft.

17. A flow control valve, as defined in claim 4, comprising markings on both a visible surface of an inlet coupler coupled to the upstream end of the central shaft and an outer surface of the bell housing for setting a flow rate of the flow control valve to a predetermined level.

18. A flow control valve as defined in claim 15, wherein the markings on the outer surface of the bell housing comprise a plurality of dashed markings, and wherein the plurality of dashed markings are optionally scored into the outside surface of the bell housing.

19. (canceled)

20. (canceled)

21. A flow control valve as defined in claim 2, wherein the integral washer of the resilient tubular member comprises a stiffening ring.

22. (canceled)

23. A method of using a flow control valve, the method comprising:
providing fluid to the flow control valve so that fluid can flow through a fluid path of the flow control valve;
moving a bell housing having an internal camming surface longitudinally relative to a central shaft of the flow control valve so that the internal camming surface moves balls supported within the central shaft of the flow control valve radially inwardly to decrease a cross-sectional area of the fluid path;
so that a rate of flow of the fluid through the flow control valve is decreased.

24. (canceled)

25. (canceled)

26. (canceled)
